(19) United States
(12) Patent Application Publication
(10) Pub. No.: US 2025/0251625 A1
(43) Pub. Date: Aug. 7, 2025

(54) Display Apparatus Having a Liquid Crystal Panel and an Optical Module

(71) Applicant: LG Display Co., Ltd., Seoul (KR)

(72) Inventor: Woong Jin Seo, Paju-si (KR)

(21) Appl. No.: 18/999,329

(22) Filed: Dec. 23, 2024

(30) Foreign Application Priority Data
Feb. 1, 2024 (KR) 10-2024-0015672

(51) Int. Cl. G02F 1/133; F21V 8/00

(52) U.S. Cl. CPC G02F 1/13312; G02B 6/0081

(57) ABSTRACT

An optical module overlaps a sensing area of a liquid crystal panel that includes pixel areas. The pixel areas include second pixel areas having a larger size than first pixel areas and third pixel areas having a smaller size than the second pixel areas. The first pixel areas are outside the sensing area. The second pixel areas and the third pixel areas repeat in a first direction within the sensing area. A length of each third pixel area in the first direction is a same as a length of each first pixel area in the first direction. Each of the third pixel areas have a same length as each second pixel area in a second direction. Thus, the visibility of a boundary between an image in the second pixel areas and the third pixel areas and an image in the first pixel areas is reduced.

### CROSS-REFERENCE TO RELATED APPLICATION

This application claims the benefit of Republic of Korea Patent Application No. 10-2024-0015672, filed on Feb. 1, 2024, which is hereby incorporated by reference in its entirety.

### BACKGROUND

### Field of Technology

The present disclosure relates to a display apparatus in which a liquid crystal panel includes a sensing area overlapping with an optical module.

### Discussion of the Related Art

Generally, a display apparatus provides an image to a user. For example, the display apparatus may include a liquid crystal panel disposed on a back-light unit. The liquid crystal panel may generate an image by using light provided from the back-light unit. For example, the liquid crystal panel may include pixel areas.

The display apparatus may include an optical module for detecting an external light. For example, the optical module may include at least one of a camera and an infrared (IR) sensor. The optical module may overlap a region of the liquid crystal panel. For example, the liquid crystal panel may include a sensing area overlapping with the optical module. The sensing area may have a relative high transmittance. For example, the sensing area may have a relative low resolution.

However, in the display apparatus, a sense of heterogeneity and incompatibility due to a difference in resolution may be greatly felt at the boundary between an image formed by pixel areas disposed in the sensing area and an image formed by pixel areas disposed outside the sensing area. Thus, in the display apparatus, quality of the image recognized by the user may be reduced.

### SUMMARY

Accordingly, the present disclosure is directed to a display apparatus that substantially obviates one or more problems due to limitations and disadvantages of the related art.

An object of the present disclosure is to provide a display apparatus capable of minimizing or at least reducing the visibility of a boundary between an image formed by pixel areas disposed in a sensing area and an image formed by pixel areas disposed outside the sensing area.

Additional advantages, objects, and features of the disclosure will be set forth in part in the description which follows and in part will become apparent to those having ordinary skill in the art upon examination of the following or may be learned from practice of the disclosure. The objects and other advantages of the disclosure may be realized and attained by the structure particularly pointed out in the written description and claims hereof as well as the appended drawings.

To achieve these objects and other advantages and in accordance with the purpose of the present disclosure, as embodied and broadly described herein, there is provided a display apparatus comprising a back-light unit. The back-light unit includes a light guide plate. A liquid crystal panel is disposed on the back-light unit. The liquid crystal panel includes first pixel areas, second pixel areas and third pixel areas. A size of each second pixel area is larger than a size of each first pixel area. A size of each third pixel area is smaller than the size of each second pixel area. An optical module spaced apart from the light guide plate overlaps a sensing area of the liquid crystal panel. The second pixel areas and the third pixel areas are repeated in a first direction within the sensing area. A length of each third pixel area in the first direction is a same as a length of each first pixel area in the first direction. Each of the third pixel areas has a same length as each of the second pixel areas in a second direction perpendicular to the first direction.

The first pixel areas may be disposed outside the sensing area.

Each of the first pixel areas may display a different color from adjacent first pixel area in the first direction. Each of the first pixel areas may display a same color as adjacent first pixel area in the second direction. Each of the second pixel areas may display a different color from adjacent second pixel area in the second direction.

Each of the second pixel areas may display a first color or a second color. The second pixel areas displaying the first color and the second pixel areas displaying the second color may be repeated in the second direction.

Each of the third pixel areas may display a same color as adjacent third pixel area in the first direction and the second direction.

Each of the third pixel areas may display green color.

A length of each second pixel area in the first direction may be an integer multiple of a length of each first pixel area in the first direction.

A length of each second pixel area in the second direction may be an integer multiple of a length of each first pixel area in the second direction. The length of each second pixel area in the second direction may be longer than the length of each second pixel area in the first direction.

Each of the first pixel areas may display red color, green color or blue color. The second pixel areas and the third pixel areas may be repeated with fourth pixel areas and fifth pixel areas in the first direction within the sensing area. Each of the fourth pixel areas and each of the fifth pixel areas may have a same length as each third pixel area in the first direction and the second direction.

Each of the fourth pixel areas may display a same color as adjacent fourth pixel area in the first direction and the second direction. Each of the fifth pixel areas may display a same color as adjacent fifth pixel area in the first direction and the second direction.

A plurality of first signal wirings extending in the second direction may be disposed between the first pixel areas, the second pixel areas and the third pixel areas. The number of the first signal wirings between adjacent second pixel area and third pixel area may be larger than the number of the first signal wirings between the first pixel areas adjacent in the first direction.

A plurality of second signal wirings extending in the first direction may be disposed between the first pixel areas, the second pixel areas and the third pixel areas. The number of the second signal wirings between the second pixel areas adjacent in the second direction and between the third pixel areas adjacent in the second direction may be larger than the number of the second signal wirings between the first pixel areas adjacent in the second direction. In addition, a boundary between the second pixel areas and the third pixel areas adjacent in the first direction may coincide with one of boundaries between the first pixel areas adjacent in the first direction. In addition, a boundary between the second pixel areas adjacent in the second direction or a boundary between the third pixel areas adjacent in the second direction may coincide with one of boundaries between the first pixel areas adjacent in the second direction.

### BRIEF DESCRIPTION OF THE DRAWINGS

The accompanying drawings, which are included to provide a further understanding of the disclosure and are incorporated in and constitute a part of this application, illustrate embodiment(s) of the disclosure and together with the description serve to explain the principle of the disclosure. In the drawings:

FIG. 1 is a view schematically showing a display apparatus according to an embodiment of the present disclosure;

FIG. 2 is a view taken along lines I-I′ and II-II′ in FIG. 1 according to an embodiment of the present disclosure;

FIG. 3 is a view showing a circuit of a pixel area within the liquid crystal panel in the display apparatus according to the embodiment of the present disclosure;

FIG. 4 is an enlarged view of K region in FIG. 2 according to an embodiment of the present disclosure;

FIG. 5 is an enlarged view of R region in FIG. 1 according to an embodiment of the present disclosure;

FIG. 6 is a view showing a first display substrate within R region of FIG. 1 in the display apparatus according to the embodiment of the present disclosure;

FIG. 7 is a view taken along line III-III′ in FIG. 5 according to an embodiment of the present disclosure;

FIG. 8 is a view taken along line IV-IV′ in FIG. 5 according to an embodiment of the present disclosure;

FIG. 9 is a graph showing intensities according to the position of light emitted from R region of FIG. 1; and

FIGS. 10 to 23 are views showing the display apparatus according to other embodiments of the present disclosure.

### DETAILED DESCRIPTION

Hereinafter, details related to the above objects, technical configurations, and operational effects of the embodiments of the present disclosure will be clearly understood by the following detailed description with reference to the drawings, which illustrate some embodiments of the present disclosure. Here, the embodiments of the present disclosure are provided in order to allow the technical sprit of the present disclosure to be satisfactorily transferred to those skilled in the art, and thus the present disclosure may be embodied in other forms and is not limited to the embodiments described below.

In addition, the same or extremely similar elements may be designated by the same reference numerals throughout the specification and in the drawings, the lengths and thickness of layers and regions may be exaggerated for convenience. It will be understood that, when a first element is referred to as being “on” a second element, although the first element may be disposed on the second element so as to come into contact with the second element, a third element may be interposed between the first element and the second element.

Here, terms such as, for example, “first” and “second” may be used to distinguish any one element with another element. However, the first element and the second element may be arbitrary named according to the convenience of those skilled in the art without departing the technical sprit of the present disclosure.

The terms used in the specification of the present disclosure are merely used in order to describe particular embodiments and are not intended to limit the scope of the present disclosure. For example, an element described in the singular form is intended to include a plurality of elements unless the context clearly indicates otherwise. In addition, in the specification of the present disclosure, it will be further understood that the terms “comprises” and “includes” specify the presence of stated features, integers, steps, operations, elements, components, and/or combinations thereof, but do not preclude the presence or addition of one or more other features, integers, steps, operations, elements, components, and/or combinations.

And, unless ‘directly’ is used, the terms “connected” and “coupled” may include that two components are “connected” or “coupled” through one or more other components located between the two components.

Unless otherwise defined, all terms (including technical and scientific terms) used herein have the same meaning as commonly understood by one of ordinary skill in the art to which example embodiments belong. It will be further understood that terms, such as those defined in commonly used dictionaries, should be interpreted as having a meaning that is consistent with their meaning in the context of the relevant art and should not be interpreted in an idealized or overly formal sense unless expressly so defined herein.

### Embodiment

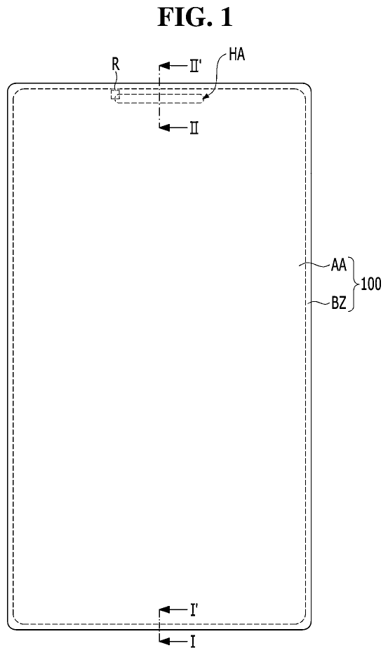

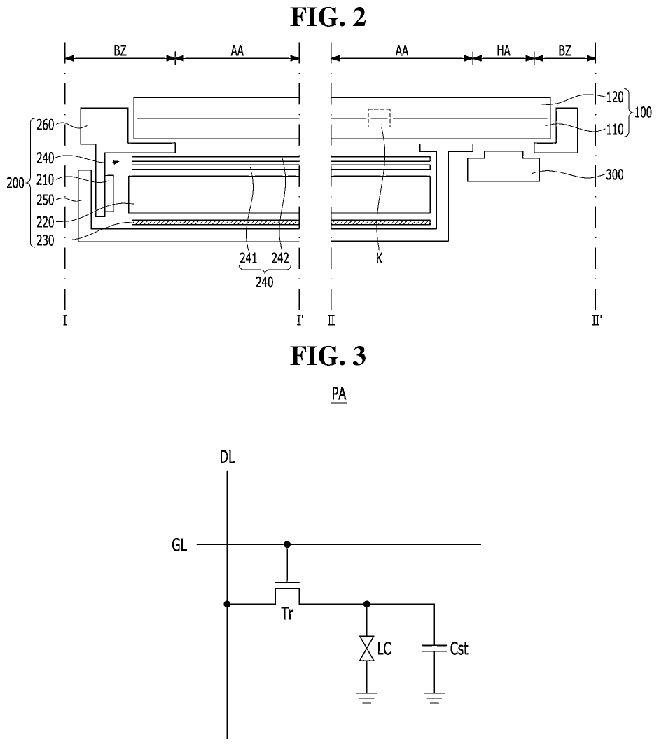

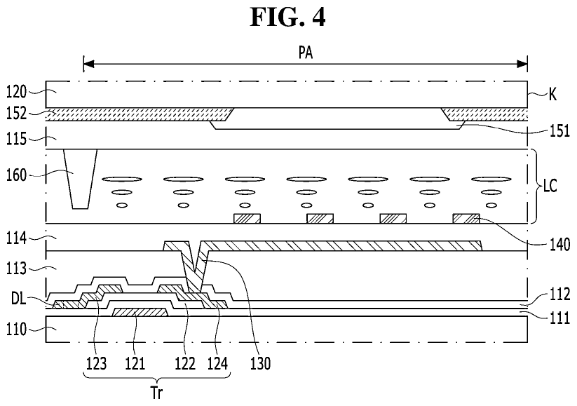

FIG. 1 is a view schematically showing a display apparatus according to an embodiment of the present disclosure. FIG. 2 is a view taken along lines I-I′ and II-II′ in FIG. 1 according to an embodiment of the present disclosure. FIG. 3 is a view showing a circuit of a pixel area within the liquid crystal panel in the display apparatus according to the embodiment of the present disclosure. FIG. 4 is an enlarged view of K region in FIG. 2 according to an embodiment of the present disclosure.

Referring to FIGS. 1 to 4, the display apparatus according to the embodiment of the present disclosure may include a liquid crystal panel 100. The liquid crystal panel 100 may generate an image provided to a user. For example, the liquid crystal panel 100 may include a plurality of pixel areas PA. Various signals may be applied to each pixel area PA through signal wirings GL and DL. For example, the signal wirings GL and DL may include gate lines GL sequentially applying a gate signal and data lines DL applying a data signal. The gate lines GL may intersect the data lines DL. For example, the gate lines GL may extend in a first direction, and the data lines DL may extend in a second direction perpendicular to the first direction. The data lines DL may be disposed on a different layer from the gate lines GL.

The liquid crystal panel 100 may include an active area AA in which the pixel areas PA are disposed, and a bezel area BZ disposed outside the active area AA. The bezel area BZ may not overlap the pixel areas PA. For example, the active area AA may be surrounded by the bezel area BZ. A gate driver electrically connected to the gate lines GL and a data driver electrically connected to the data lines DL may be disposed outside the active area AA. For example, each of the signal wirings GL and DL may include a region overlapping with the bezel area BZ of the liquid crystal panel 100.

The liquid crystal panel may include a liquid crystal layer LC disposed between a first display substrate 110 and a second display substrate 120. The first display substrate 110 and the second display substrate 120 may include an insulating material. The first display substrate 110 and the second display substrate 120 may include a transparent material. For example, the first display substrate 110 and the second display substrate 120 may include glass or plastic. The second display substrate 120 may include a different material from the first display substrate 110. The liquid crystal layer LC may include liquid crystal of various modes. For example, the liquid crystal layer LC may include an IPS mode liquid crystal. The liquid crystal of the liquid crystal layer LC overlapping with each pixel area PA may be rotated by a vertical electric field or a horizontal electric field formed in the corresponding pixel area by the gate signal and the data signal. For example, a pixel electrode 130 and a common electrode 140 overlapping with a portion of the pixel electrode 130 may be disposed in each pixel area PA for formation of the horizontal electric field.

A constant power voltage may be supplied to the common electrode 140 of each pixel area PA. A driving voltage corresponding to the data signal applied to each pixel area PA may be supplied to the pixel electrode 130 of the corresponding pixel area PA according to the gate signal applied to the corresponding pixel area PA. That is, in the display apparatus according to the embodiment of the present disclosure, a horizontal electric field by the driving voltage applied to the pixel electrode 130 and the power voltage applied to the common electrode 140 in each pixel area PA may be formed in the corresponding pixel area PA. The driving voltage applied to the pixel electrode 130 of each pixel area PA may be maintained for one frame. For example, at least one thin film transistor Tr and a storage capacitor Cst may be disposed in each pixel area PA.

The thin film transistor Tr of each pixel area PA may generate the driving voltage corresponding to the data signal applied to the corresponding pixel area PA according to the gate signal applied to the corresponding pixel area PA. The thin film transistor Tr of each pixel area PA may be electrically connected to one of the gate lines GL and one of the data lines DL. For example, the thin film transistor Tr of each pixel area PA may include a gate electrode 121 electrically connected to one of the gate lines GL, a semiconductor pattern 122 including a region overlapping with the gate electrode 121, a drain electrode 123 electrically connected to an end of the semiconductor pattern 122, and a source electrode 124 electrically connected to another end of the semiconductor pattern 122.

The gate electrode 121 may include a conductive material. For example, the gate electrode 121 may include a metal, such as aluminum (Al), chrome (Cr), copper (Cu), molybdenum (Mo), titanium (Ti) and tungsten (W). The semiconductor pattern 122 may be disposed on the gate electrode 121. The semiconductor pattern 122 may include a semiconductor. For example, the semiconductor pattern 122 may include amorphous silicon (a-Si), polycrystalline silicon (poly-Si) and an oxide semiconductor, such as IGZO. The semiconductor pattern 122 may include a channel region disposed between a drain region and a source region. For example, the gate electrode 121 may overlap the channel region of the semiconductor pattern 122. The drain region and the source region of the semiconductor pattern 122 may be disposed outside the gate electrode 121.

The drain region and the source region of the semiconductor pattern 122 may have a lower resistance than the channel region of the semiconductor pattern 122. For example, the drain region and the source region of the semiconductor pattern 122 may include a conductive region of an oxide semiconductor. The channel region of the semiconductor pattern 122 may be a region of an oxide semiconductor, which is not conductorized. The semiconductor pattern 122 may be spaced apart from the gate electrode 121. The semiconductor pattern 122 may be insulated from the gate electrode 121. For example, the channel region of the semiconductor pattern 122 may have an electrical conductivity corresponding to a voltage applied to the gate electrode 121. The drain region of the semiconductor pattern 122 may be electrically connected to the source region of the semiconductor pattern 122 according to a signal applied to the gate electrode 121.

The drain electrode 123 and the source electrode 124 may include a conductive material. For example, the drain electrode 123 and the source electrode 124 may include a metal, such as aluminum (Al), chrome (Cr), copper (Cu), molybdenum (Mo), titanium (Ti) and tungsten (W). The drain electrode 123 and the source electrode 124 may include a different material from the gate electrode 121. For example, the drain electrode 123 and the source electrode 124 may be disposed on a different layer from the gate electrode 121. The source electrode 124 may be disposed on a same layer as the drain electrode 123. The source electrode 124 may be formed by a same process as the drain electrode 123. For example, the source electrode 124 may be formed simultaneously with the drain electrode 123.

The drain electrode 123 may be electrically connected to the drain region of the semiconductor pattern 122. The source electrode 124 may be electrically connected to the source region of the semiconductor pattern 122. The drain electrode 123 and the source electrode 124 may be insulated from the gate electrode 121. The source electrode 124 may be spaced apart from the drain electrode 123. For example, the drain electrode 123 of each pixel area PA may be electrically connected to one of the data lines DL. The pixel electrode 130 of each pixel area PA may be electrically connected to the source electrode 124 of the corresponding pixel area PA.

The storage capacitor Cst of each pixel area PA may maintain a signal applied to the gate electrode 121 of the corresponding pixel area PA. For example, the storage capacitor Cst of each pixel area PA may be electrically connected to the gate electrode 121 of the corresponding pixel area PA and a power voltage supply line supplying the power voltage.

The thin film transistor Tr and the storage capacitor Cst of each pixel area PA may be disposed between the first display substrate 110 and the liquid crystal layer LC. A plurality of insulating layers 111, 112, 113 and 114 for preventing unnecessary electrical connection may be disposed between the first display substrate 110 and the liquid crystal layer LC. For example, a gate insulating layer 111, a device passivation layer 112, a planarization layer 113 and an interlayer insulating layer 114 may be disposed between the first display substrate 110 and the liquid crystal layer LC.

The gate insulating layer 111 may be disposed close to the first display substrate 110. The semiconductor pattern 122 of each pixel area PA may be insulated from the gate electrode 121 of the corresponding pixel area PA by the gate insulating layer 111. For example, the gate insulating layer 111 may cover the gate electrode 121 of each pixel area PA. The semiconductor pattern 122 of each pixel area PA may be disposed on the gate insulating layer 111. The drain electrode 123 and the source electrode 124 of each pixel area PA may be in direct contact with a portion of the semiconductor pattern 122 in the corresponding pixel area PA, respectively. For example, the drain electrode 123 and the source electrode 124 of each pixel area PA may be disposed on the gate insulating layer 111. The gate insulating layer 111 may include an insulating material. For example, the gate insulating layer 111 may include an inorganic insulating material, such as silicon oxide (SiOx) and silicon nitride (SiNx).

The device passivation layer 112 may be disposed on the gate insulating layer 111. The device passivation layer 112 may prevent or at least reduce damage of the thin film transistor Tr in each pixel area PA due to external impact and moisture. For example, the semiconductor pattern 122, the drain electrode 123 and the source electrode 124 of each pixel area PA may be covered by the device passivation layer 112. The device passivation layer 112 may include an insulating material. For example, the device passivation layer 112 may include an inorganic insulating material, such as silicon oxide (SiOx) and silicon nitride (SiNx).

The planarization layer 113 may be disposed on the device passivation layer 112. The planarization layer 113 may remove a thickness difference due to the thin film transistor Tr and the storage capacitor Cst of each pixel area PA. For example, an upper surface of the planarization layer 113 toward the liquid crystal layer LC may be parallel to an upper surface of the first display substrate 110 toward the liquid crystal layer LC. The planarization layer 113 may include an insulating material. The planarization layer 113 may include a different material from the passivation layer 112. The planarization layer 113 may include a material having a relative high fluidity. For example, the planarization layer 113 may include an organic insulating material.

The interlayer insulating layer 114 may be disposed between the planarization layer 113 and the liquid crystal layer LC. The common electrode 140 of each pixel area PA may be insulated from the pixel electrode 130 of the corresponding pixel area PA by the interlayer insulating layer 114. For example, the interlayer insulating layer 114 may cover the pixel electrode 130 of each pixel area PA. The common electrode 140 of each pixel area PA may be disposed between the interlayer insulating layer 114 and the liquid crystal layer LC. The interlayer insulating layer 114 may include an insulating material. For example, the interlayer insulating layer 114 may include an inorganic insulating material.

Color filters 151, a black matrix 152 and an upper passivation layer 115 may be disposed between the liquid crystal layer LC and the second display substrate 120. The color filters 151 may overlap the pixel areas PA. For example, each of the color filters 151 may overlap one of the pixel areas PA. Each of the color filters 151 may display a specific color using light which passes through the liquid crystal layer LC. For example, light passing through each color filter 151 may display one of red color, blue color and green color. The black matrix 152 may be disposed side by side with the color filters 151. For example, an end of each color filter 151 may overlap the black matrix 152. The black matrix 152 may include a material reflecting or absorbing light. For example, the light passing through the liquid crystal layer LC of each pixel area PA may be emitted through the color filter 151 of the corresponding pixel area PA, which is disposed in a region defined by the black matrix 152. Thus, in the display apparatus according to the embodiment of the present disclosure, an image including various colors may be provided to the user.

The black matrix 152 may overlap the signal wirings GL and DL. The thin film transistor Tr and the storage capacitor Cst of each pixel area PA may overlap the black matrix 152. Therefore, in the display apparatus according to the embodiment of the present disclosure, the thin film transistor Tr and the storage capacitor Cst of each pixel area PA and the signal wirings GL and DL may not be recognized by the user due to the black matrix 152. That is, in the display apparatus according to the embodiment of the present disclosure, deterioration in quality of the image recognized by the user due to the thin film transistor Tr and the storage capacitor Cst of each pixel area PA and the signal wirings GL and DL may be prevented or at least reduced. The color filters 151 and the black matrix 152 may be covered by the upper passivation layer 115. The upper passivation layer 115 may prevent or at least reduce damage of the color filters 151 and the black matrix 152 due to the external impact and moisture. The upper passivation layer 115 may include an insulating material. For example, the upper passivation layer 115 may include an inorganic insulating material, such as silicon oxide (SiOx) and silicon nitride (SiNx).

A spacer 160 may be disposed between the interlayer insulating layer 114 and the upper passivation layer 115. The spacer 160 may maintain a space between the interlayer insulating layer 114 and the upper passivation layer 115. Thus, in the display apparatus according to the embodiment of the present disclosure, the liquid crystal layer LC of each pixel area PA may have a same thickness. Therefore, in the display apparatus according to the embodiment of the present disclosure, the light passing through the liquid crystal layer LC of each pixel area PA may have a same optical path. And, in the display apparatus according to the embodiment of the present disclosure, the light passing through the liquid crystal layer LC of each pixel area PA may have a same luminance as the light passing through the liquid crystal layer LC of the pixel area PA, in which a horizontal electric field same as that of the corresponding pixel area PA is formed.

The liquid crystal panel 100 may be disposed on a back-light unit 200. The back-light unit 200 may supply light to the liquid crystal panel 100. For example, the liquid crystal panel 100 may generate the image provided to the user using the light supplied from the back-light unit 200. The back-light unit 200 may include a light source device 210, a light guide plate 220, a reflecting plate 230, an optical sheet 240, a cover bottom 250 and a middle frame 260.

The light source device 210 may supply light to the liquid crystal panel 100 through the light guide plate 220. For example, the light source device 210 may be disposed on a side surface of the light guide plate 220. The light source device 210 may be a self-luminous device capable of generating and emitting light. For example, the light source device 210 may include LED. The liquid crystal panel 100 may be disposed on an upper surface of the light guide plate 220. The reflecting plate 230 may be disposed on a lower surface of the light guide plate 220. The lower surface of the light guide plate 220 may be opposite to the upper surface of the light guide plate 220. For example, the light guide plate 220 may be disposed between the reflecting plate 230 and the liquid crystal panel 100. The reflecting plate 230 may include a material capable of reflecting light. For example, the reflecting plate 230 may include a metal, such as aluminum (Al) and silver (Ag). Thus, in the display apparatus according to the embodiment of the present disclosure, light emitted through the lower surface of the light guide plate 220 may be reflected toward the liquid crystal panel 100 by the reflecting plate 230. The optical sheet 240 may be disposed between the light guide plate 220 and the liquid crystal panel 100. The light supplied to the liquid crystal panel 100 through the light guide plate 220 may have uniform luminance overall by the optical sheet 240. For example, the optical sheet 240 may have a stacked structure of a prism sheet 241 and a diffusion sheet 242. Therefore, in the display apparatus according to the embodiment of the present disclosure, the light may be uniformly supplied to an entire area of the liquid crystal panel 100.

The light source device 210, the light guide plate 220, the reflecting plate 230 and the optical sheet 240 may be accommodated in the cover bottom 250. The cover bottom 250 may include an insulating material. For example, the cover bottom 250 may include plastic. The cover bottom 250 may include a bottom surface and a side-wall protruding from an edge of the bottom surface. The reflecting plate 230 may be disposed between the light guide plate 220 and the bottom surface of the cover bottom 250. The light source device 210, the light guide plate 220 and the optical sheet 240 may be disposed within a space formed by the side-wall of the cover bottom 250. For example, the side-wall of the cover bottom 250 may surround the light source device 210, the light guide plate 220 and the optical sheet 240.

The middle frame 260 may support the liquid crystal panel 100. The middle frame 260 may be coupled with the cover bottom 250. For example, the middle frame 260 may include a coupling region extending between the cover bottom 250 and the light guide plate 220. The light source device 210 may be fixed on the coupling region of the middle frame 260. For example, the light source device 210 may be attached to the coupling region of the middle frame 260 by an adhesive element. The middle frame 260 may include a seating region extending between the optical sheet 240 and the liquid crystal panel 100. The seating region of the middle frame 260 may overlap an edge of the optical sheet 240. For example, the seating region of the middle frame 260 may overlap the bezel area BZ of the liquid crystal panel 100. The active area AA of the liquid crystal panel 100 may not overlap the seating region of the middle frame 260. For example, a central region of the optical sheet 240 may be exposed by the middle frame 260. The seating region of the middle frame 260 may be in direct contact with the optical sheet 240. Thus, in the display apparatus according to the embodiment of the present disclosure, the movement of the optical sheet 240 may be prevented by the middle frame 260.

The optical module 300 may detect an external light through the liquid crystal panel 100. For example, the optical module 300 may include at least one of a camera and an IR sensor. The optical module 300 may overlap a portion of the liquid crystal panel 100. For example, the liquid crystal panel 100 may include a sensing area HA overlapping with the optical module 300. The sensing area HA may be disposed within the active area AA. The light guide plate 220 may be disposed outside the sensing area HA. The optical module 300 may be disposed on the cover bottom 250. For example, the cover bottom 250 may include a cover hole overlapping with the sensing area HA of the liquid crystal panel 100.

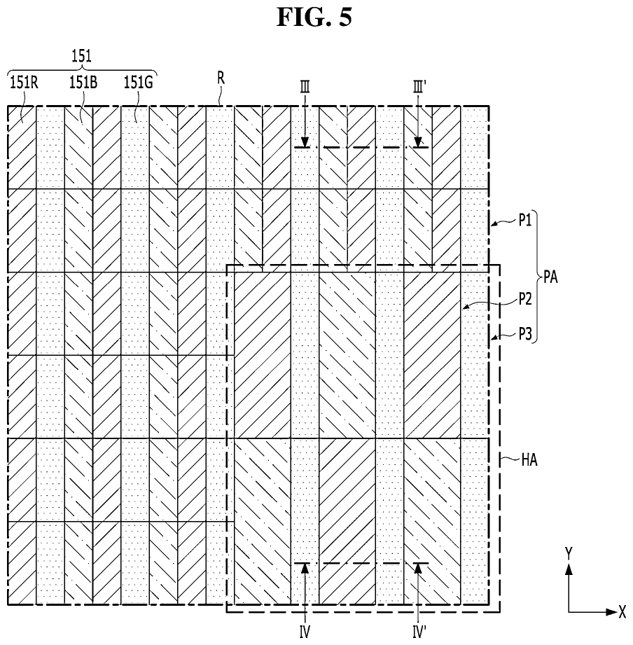

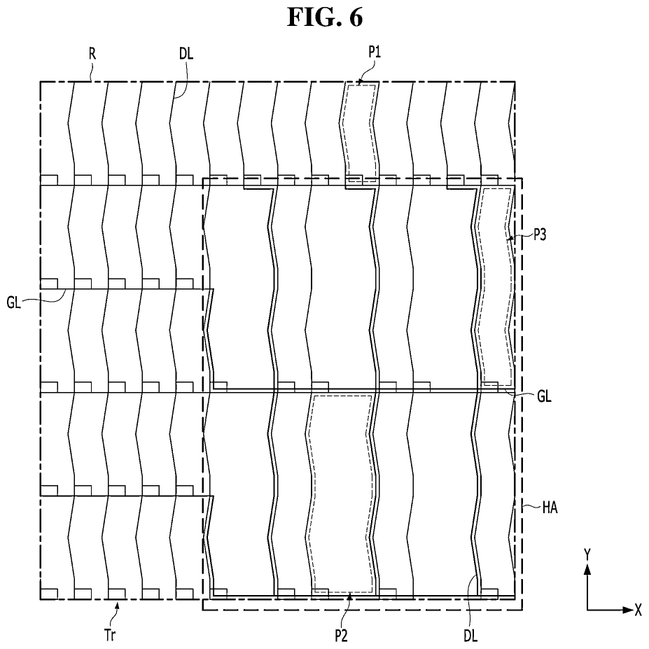

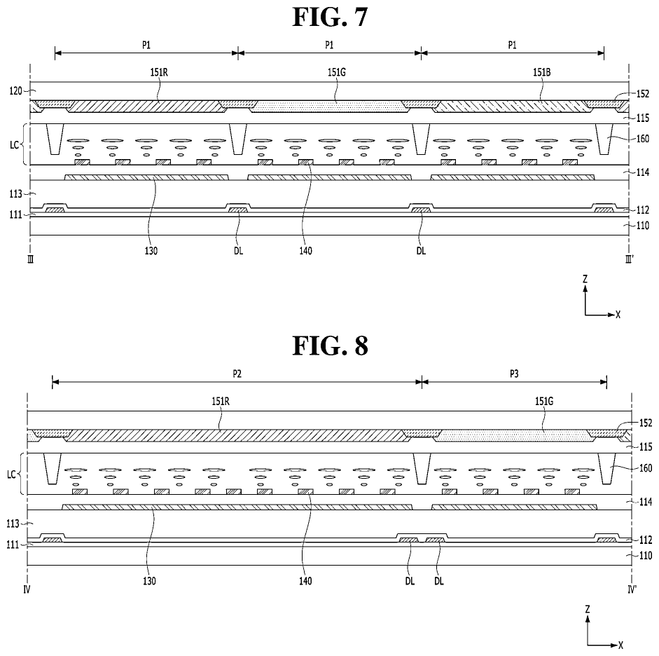

FIG. 5 is an enlarged view of R region in FIG. 1 according to an embodiment of the present disclosure. FIG. 6 is a view showing a first display substrate within R region of FIG. 1 in the display apparatus according to the embodiment of the present disclosure. FIG. 7 is a view taken along line III-III′ in FIG. 5 according to an embodiment of the present disclosure. FIG. 8 is a view taken along line IV-IV′ in FIG. 5 according to an embodiment of the present disclosure.

Referring to FIGS. 5 to 8, the pixel areas PA may include first pixel areas P1, second pixel areas P2, and third pixel areas P3. The first pixel areas P1 may be disposed outside the sensing area HA within the active area AA. The first pixel areas P1 may be disposed side by side in a first direction X and a second direction Y perpendicular to the first direction X. The first pixel areas P1 may display various colors. For example, one of a red color filter 151R that light passing through displays red color, a green color filter 151G that light passing through displays green color, and a blue color filter 151B that light passing through displays blue color may be disposed on each first pixel area P1. Each of the first pixel areas P1 may display a different color from the first pixel area P1 adjacent in the first direction X. For example, the red color filter 151R, the green color filter 151G and the blue color filter 151B may be repeated on the first pixel areas P1 disposed side by side in the first direction X. The first pixel areas P1 adjacent to each other in the first direction X may be disposed in a same order as the first pixel areas P1 adjacent to the corresponding first pixel areas P1 in the second direction Y. For example, each of the first pixel areas P1 may display a same color as the first pixel area P1 adjacent in the second direction Y. The color filter 151R, 151G and 151B on each first pixel area P1 may include a same material as the color filter 151R, 151G and 151B on the first pixel area P1 adjacent in the second direction Y.

The second pixel areas P2 and the third pixel areas P3 may be disposed within the sensing area HA. Each of the second pixel areas P2 and each of the third pixel areas P3 may have a larger size than each of the first pixel areas P1. Thus, in the display apparatus according to the embodiment of the present disclosure, the sensing area HA of the liquid crystal panel 100 may have a relative high transmittance. That is, in the display apparatus according to the embodiment of the present disclosure, the sensing area HA may have a relative low resolution due to sizes of the second pixel areas P2 and sizes of the third pixel areas P3. Therefore, in the display apparatus according to the embodiment of the present disclosure, light may be sufficiently supplied to the optical module 300 through the sensing area HA of the liquid crystal panel 100.

Each of the second pixel areas P2 may have a longer length than each first pixel area P1 in the first direction X and the second direction Y. A length of the second pixel area P2 in the first direction X may be an integer multiple of a length of each first pixel area P1 in the first direction X. For example, a length of each second pixel area P2 in the first direction X may be twice a length of each first pixel area P1 in the first direction X. A length of the second pixel area P2 in the second direction Y may be an integer multiple of a length of each first pixel area P1 in the second direction Y. For example, a length of each second pixel area P2 in the second direction Y may be twice a length of each first pixel area P1 in the second direction Y. A size of each second pixel area P2 may be four times a size of each first pixel area P1.

Each of the third pixel areas P3 may have a smaller size than each second pixel area P2. For example, a length of each third pixel area P3 in the first direction X may be smaller than the length of each second pixel area P2 in the first direction X, and each of the third pixel areas P3 may have a same length as each second pixel area P2 in the second direction Y. The second pixel areas P2 and the third pixel areas P3 may be repeated in the first direction X within the sensing area HA. The second pixel areas P2 and the third pixel areas P3 may be disposed side by side in the second direction Y within the sensing area HA. Thus, in the display apparatus according to the embodiment of the present disclosure, a boundary between the second pixel areas P2 and the third pixel areas P3 adjacent in the first direction X within the sensing area HA may be arranged with one of boundaries between the first pixel areas P1 adjacent in the first direction X at the outside of the sensing area HA. And, in the display apparatus according to the embodiment of the present disclosure, a boundary between the second pixel areas P2 adjacent in the second direction Y within the sensing area HA and a boundary between the third pixel areas P3 adjacent in the second direction Y within the sensing area HA may be arranged with one of boundaries between the first pixel areas P1 adjacent in the second direction Y at the outside of the sensing area HA. Therefore, in the display apparatus according to the embodiment of the present disclosure, a sense of heterogeneity and incompatibility may be prevented due to the fact that the boundary between the second pixel areas P2 and the third pixel areas P3 within the sensing area HA does not match the boundary between the first pixel areas P1 disposed outside the sensing area HA.

The signal wirings GL and DL may extend along the boundary between the second pixel areas P2 and the third pixel areas P3 in the sensing area HA. Thus, in the display apparatus according to the embodiment of the present disclosure, the gate lines GL extending in the first direction X and the data lines DL extending in the second direction Y may partially bypass within the sensing area HA according to the size of each second pixel area P2 and the size of each third pixel area P3. That is, in the display apparatus according to the embodiment of the present disclosure, the number of the data lines DL disposed between the second pixel area P2 and the third pixel area P3, which are disposed adjacent in the first direction X within the sensing area HA, may be greater than the number of the data lines DL disposed between the first pixel areas P1 adjacent in the first direction X at the outside of the sensing area HA, and the number of the gate lines GL disposed between the second pixel areas P2 or between the third pixel areas P3 adjacent in the second direction Y within the sensing area HA, may be greater than the number of the gate lines GL disposed between the first pixel areas P1 adjacent in the second direction Y at the outside of the sensing area HA. For example, in the display apparatus according to the embodiment of the present disclosure, two data lines DL may be disposed between the second pixel area P2 and the third pixel area P3, which are disposed adjacent in the first direction X within the sensing area HA, and a single data line DL may be disposed between the first pixel areas P1 adjacent in the first direction X at the outside of the sensing area HA. The black matrix 152 may be disposed between the second pixel areas P2 and the third pixel areas P3 within the sensing area HA. For example, a region defined by the black matrix 152 may have a relatively large size in the sensing area HA. Therefore, in the display apparatus according to the embodiment of the present disclosure, transmittance of the sensing area HA may be relatively high by differences in a distance between the signal wirings GL and DL, differences in a size defined by the black matrix 152, differences in the number of the thin film transistors Tr disposed per unit area and differences in the number of the storage capacitors Cst disposed per unit area.

The third pixel areas P3 may display a different color from the second pixel areas P2. Each of the third pixel areas P3 may display a same color as the third pixel area P3 adjacent in the first direction X and the second direction Y. For example, the green color filter 151G may be disposed on each third pixel area P3. Each of the third pixel areas P3 may display a same color as the first pixel area P1 disposed side by side with the corresponding third pixel area P3 in the second direction Y. For example, each of the third pixel areas P3 may be disposed side by side in the second direction Y with the first pixel area P1 in which the green color filter 151G is disposed. Thus, in the display apparatus according to the embodiment of the present disclosure, the color filter 151R, 151G and 151B of a specific color may be recognized as continuous at the boundary between the active area AA and the sensing area HA. For example, in the display apparatus according to the embodiment of the present disclosure, the green color filter 151G may be recognized as continuous at the boundary between the active area AA and the sensing area HA in the second direction Y.

Each of the second pixel areas P2 may display a different color from the second pixel area P2 adjacent in the first direction X and the second direction Y. The color displayed by the second pixel areas P2 and the third pixel areas P3 may be a same as the color displayed by the first pixel areas P1. For example, in the display apparatus according to the embodiment of the present disclosure, the red color filter 151R or the blue color filter 151B may be disposed on each second pixel area P2. The second pixel areas P2 displaying different colors may be repeated in the first direction X and the second direction Y. For example, in the display apparatus according to the embodiment of the present disclosure, the second pixel areas P2 in which the red color filter 151R is disposed and the second pixel areas P2 in which the blue color filter 151B is disposed may be repeated in the first direction X and the second direction Y.

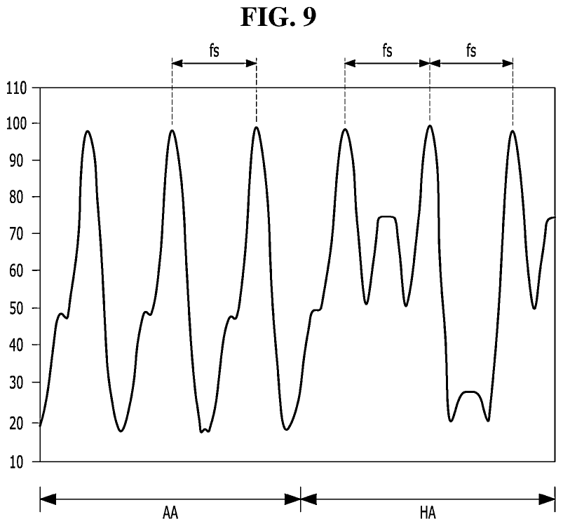

FIG. 9 is a graph showing intensities according to the position of light emitted from the active area AA and light emitted from the sensing area HA.

Referring to FIG. 9, the light emitted from the sensing area HA in which the second pixel areas P2 and the third pixel areas P3 are disposed may have a spatial frequency fs that is the same as the light emitted from the active area AA in which the first pixel areas P1. Here, the spatial frequency means a distance at which waves are repeated. That is, in the display apparatus according to the embodiment of the present disclosure, a peak interval of the light emitted from the sensing area HA may be a same as a peak interval of the light emitted from the active area AA. Thus, in the display apparatus according to the embodiment of the present disclosure, a sense of heterogeneity and incompatibility for the boundary between an image generated by the second pixel areas P2 and the third pixel areas P3 which are disposed within the sensing area HA and an image generated by the first pixel areas P1 disposed outside the sensing area HA may be minimized or at least reduced. Therefore, in the display apparatus according to the embodiment of the present disclosure, visibility for the boundary between an image generated by the second pixel areas P2 and the third pixel areas P3 which are disposed within the sensing area HA and an image generated by the first pixel areas P1 disposed outside the sensing area HA may be reduced.

Accordingly, the display apparatus according to the embodiment of the present disclosure may include the liquid crystal panel 100 on the back-light unit 200 and the optical module 300 overlapping with the sensing area HA of the liquid crystal panel 100, wherein the liquid crystal panel 100 may include the first pixel areas P1, the second pixel areas P2 and the third pixel areas P3, wherein the second pixel areas P2 and the third pixel areas P3 repeated in the first direction X within the sensing area HA may have a larger size than the first pixel areas P1 disposed outside the sensing area HA, wherein the length of each third pixel area P3 in the first direction X may be a same as the length of each first pixel area P1 in the first direction X, and wherein each of the third pixel areas P3 may have a same length as each second pixel area P2 in the second direction Y. Thus, in the display apparatus according to the embodiment of the present disclosure, the light emitted from the sensing area HA may have substantially a same spatial frequency as the light emitted from the first pixel areas P1. That is, in the display apparatus according to the embodiment of the present disclosure, a sense of heterogeneity and incompatibility at the boundary between the image by the light emitted from the sensing area HA and the image by the light emitted from the first pixel areas P1 may be minimized. And, in the display apparatus according to the embodiment of the present disclosure, visibility for the boundary between the image by the light emitted from the sensing area HA and the image by the light emitted from the first pixel areas P1 may be reduced. Therefore, in the display apparatus according to the embodiment of the present disclosure, quality of the image recognized by the user may be improved.

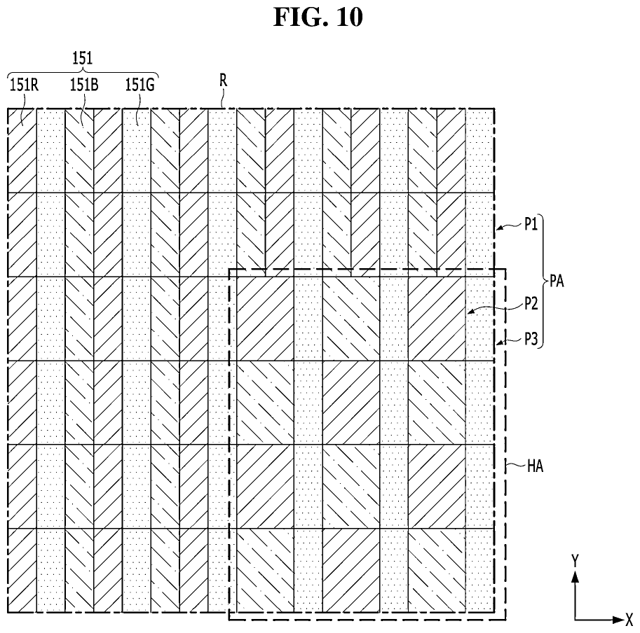

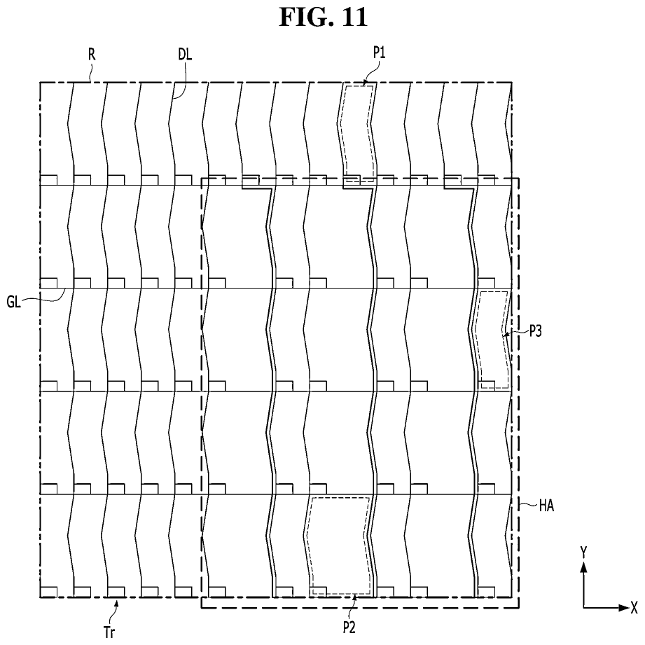

The display apparatus according to the embodiment of the present disclosure is described that each of the second pixel areas P2 and each of the third pixel areas P3 may have a length twice that of each first pixel area P1 in the first direction X and the second direction Y. However, in the display apparatus according to another embodiment of the present disclosure, one of the signal wirings GL and DL may not bypass within the sensing area HA. For example, in the display apparatus according to another embodiment of the present disclosure, each of the second pixel areas P2 and the third pixel areas P3, which are disposed within the sensing area HA, may have a same length as each first pixel area P1 disposed outside the sensing area HA in the second direction Y, as shown in FIGS. 10 and 11. That is, in the display apparatus according to another embodiment of the present disclosure, the gate lines GL may not bypass in the sensing area HA. Thus, in the display apparatus according to another embodiment of the present disclosure, a process of forming the gate lines GL may be simplified. Therefore, in the display apparatus according to another embodiment of the present disclosure, deterioration in process efficiency due to the sensing area HA may be minimized.

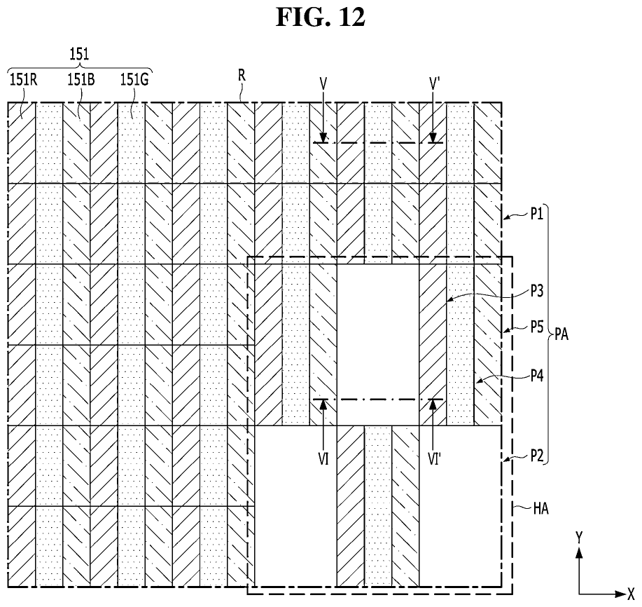

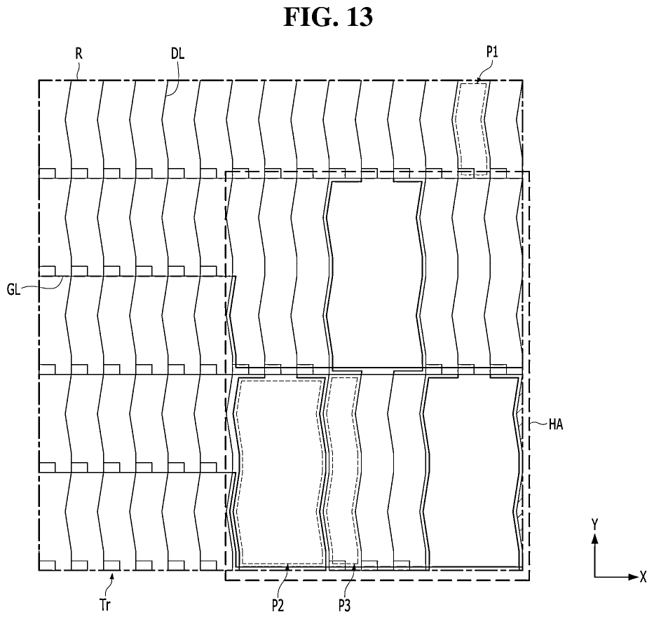

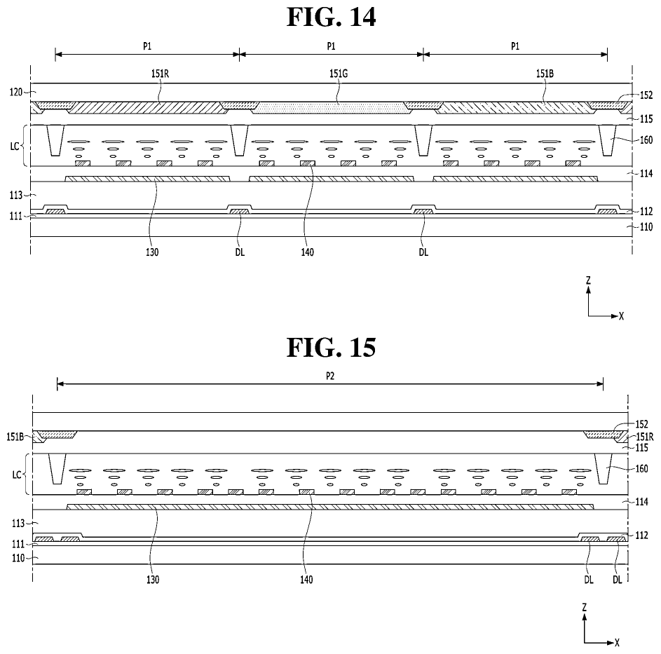

The display apparatus according to the embodiment of the present disclosure is described that the second pixel areas P2 in which the red color filter 151R is disposed, the third pixel areas P3 in which the green color filter 151G is disposed, and the second pixel areas P2 in which the blue color filter 151B is disposed may be repeated within the sensing area HA in the first direction X. However, in the display apparatus according to another embodiment of the present disclosure, the second pixel areas P2 within the sensing area HA may display white color. For example, in the display apparatus according to another embodiment of the present disclosure, the third pixel areas P3 in which the red color filter 151R is disposed, fourth pixel areas P4 in which the green color filter 151G is disposed, fifth pixel areas P5 in which the blue color filter 151B is disposed, and the second pixel areas P2 in which the color filters 151R, 151G and 151B are not disposed may be repeated in the first direction X within the sensing area HA, as shown in FIGS. 12 to 15. Thus, in the display apparatus according to another embodiment of the present disclosure, transmittance of the second pixel areas P2 may be improved. And, in the display apparatus according to another embodiment of the present disclosure, the amount of the external light passing through the sensing area HA may be increased by the second pixel areas P2.

The fourth pixel areas P4 and the fifth pixel areas P5 may have a same size as the third pixel areas P3. For example, a length of each fourth pixel area P4 and a length of each fifth pixel area P5 in the first direction X may be a same as the length of each third pixel area P3 in the first direction X, and a length of each fourth pixel area P4 and a length of each fifth pixel area P5 in the second direction Y may be a same as the length of each third pixel area P3 in the second direction Y. The length of each second pixel area P2 in the second direction Y may be a same as the length of each fifth pixel area P5 in the second direction Y. Each of the second pixel areas P2 may have a length in the first direction X same as the sum of the length of each third pixel area P3 in the first direction X, the length of each fourth pixel area P4 in the first direction X, and the length of each fifth pixel area P5 in the first direction X. That is, in the display apparatus according to another embodiment of the present disclosure, blocks in which one of the third pixel areas P3, one of the fourth pixel areas P4 and one of the fifth pixel areas P5 are disposed side by side and the second pixel areas P2 may be repeated in the second direction Y. Thus, in the display apparatus according to another embodiment of the present disclosure, a spatial frequency of the light emitted from the sensing area HA may be maintained equal to a spatial frequency of the light emitted from the first pixel areas P1, and transmittance of the sensing area HA may be further increased. Therefore, in the display apparatus according to another embodiment of the present disclosure, a sense of heterogeneity and incompatibility for the boundary between the image generated by the light emitted from the sensing area HA and the image generated by the light emitted from the first pixel areas P1 may be minimized, and the amount of the external light provided to the optical module through the sensing area HA may be increased. And, in the display apparatus according to another embodiment of the present disclosure, characteristics of detecting the external light by the optical module may be improved, without reducing the quality of the image provided to the user.

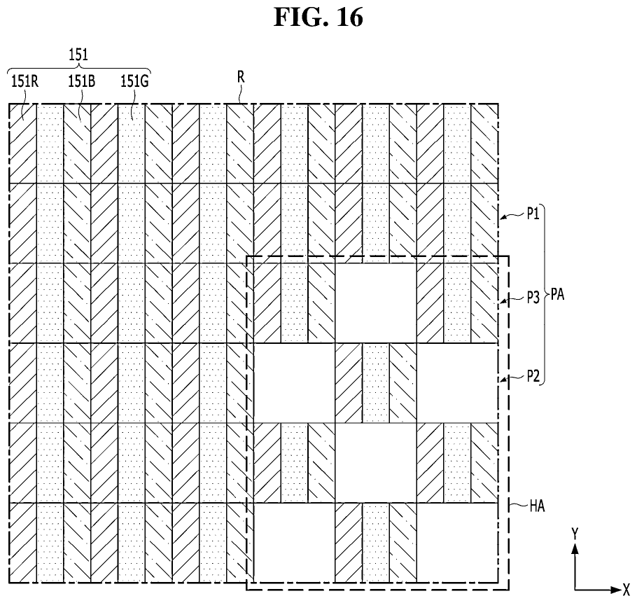

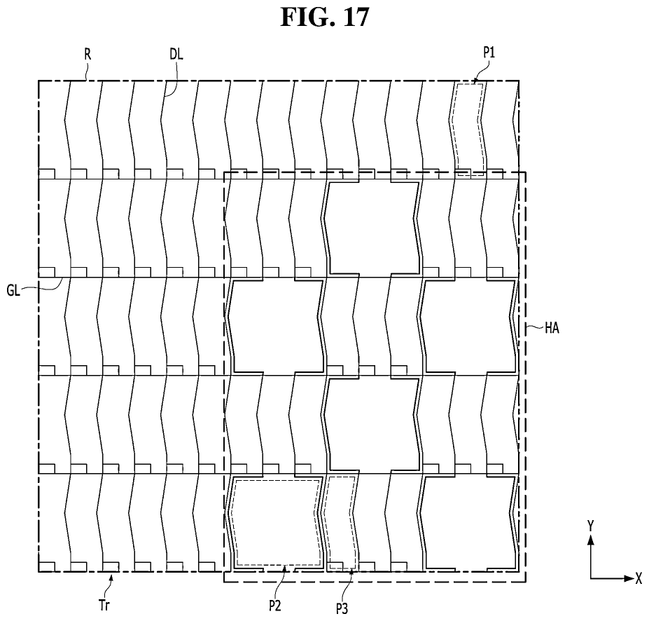

In the display apparatus according to another embodiment of the present disclosure, the third pixel areas P3 in which the red color filter 151R is disposed, the third pixel areas P3 in which the blue color filter 151B is disposed, the third pixel areas P3 in which the green color filter 151G is disposed, and the second pixel areas P2 in which the color filters 151R, 151G and 151B are not disposed may have a same length in the second direction Y, as shown in FIGS. 16 and 17. Thus, in the display apparatus according to another embodiment of the present disclosure, differences in resolution of the sensing area HA and the active area AA may be minimized, and the amount of the external light provided to the optical module through the sensing area HA may be increased.

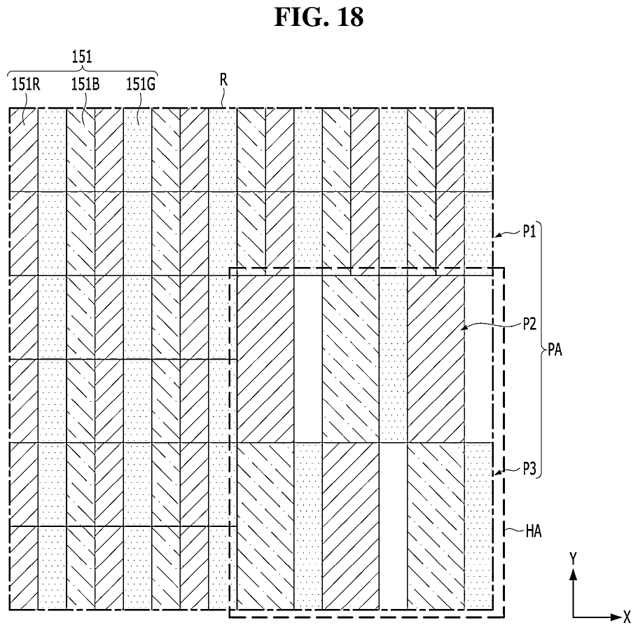

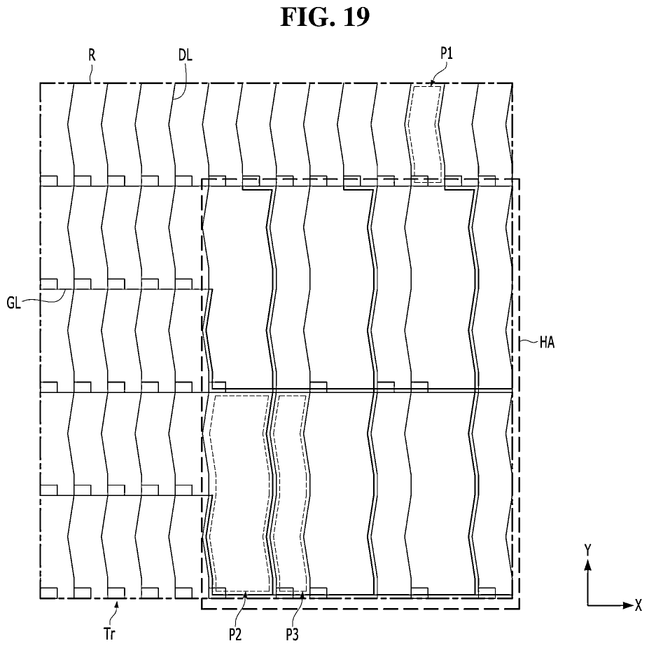

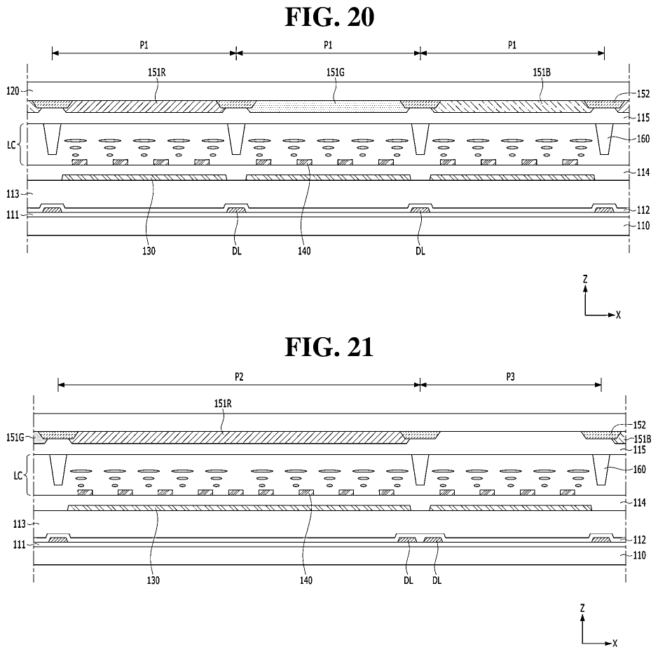

In the display apparatus according to another embodiment of the present disclosure, a region in which the color filters 151R, 151G and 151B are not disposed within the sensing area HA may be a smaller size than a region in which the color filters 151R, 151G and 151B are disposed within the sensing area HA. For example, in the display apparatus according to another embodiment of the present disclosure, the second pixel areas P2 in which the red color filter 151R is disposed and the second pixel areas P2 in which the blue color filter 151B is disposed may be repeated in the first direction X and the second direction Y within the sensing area HA, and the third pixel areas P3 in which the green color filter 151G is disposed and the third pixel areas P3 in which the color filters 151R, 151G and 151B are not disposed may be repeated between the second pixel areas P2 adjacent in the first direction X and between the second pixel areas P2 adjacent in the second direction Y, as shown in FIGS. 18 to 21. That is, in the display apparatus according to another embodiment of the present disclosure, the second pixel areas P2 in which the red color filter 151R is disposed, the third pixel areas P3 displaying white color, the second pixel areas P2 in which the blue color filter 151B is disposed, and the third pixel areas P3 in which the green color filter 151G is disposed may be repeated in the first direction X. Thus, in the display apparatus according to another embodiment of the present disclosure, luminance differences between the image generated by the light emitted from the sensing area HA and the image generated by the light emitted from the first pixel areas P1 may be minimized. Therefore, in the display apparatus according to another embodiment of the present disclosure, deterioration in quality of the image recognized to the user due to the luminance differences may be prevented, and the amount of the external light provided to the optical module through the sensing area HA may be increased.

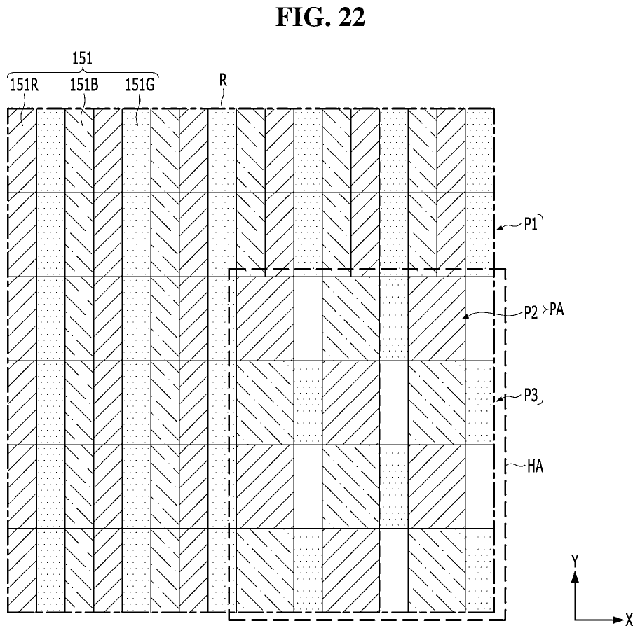

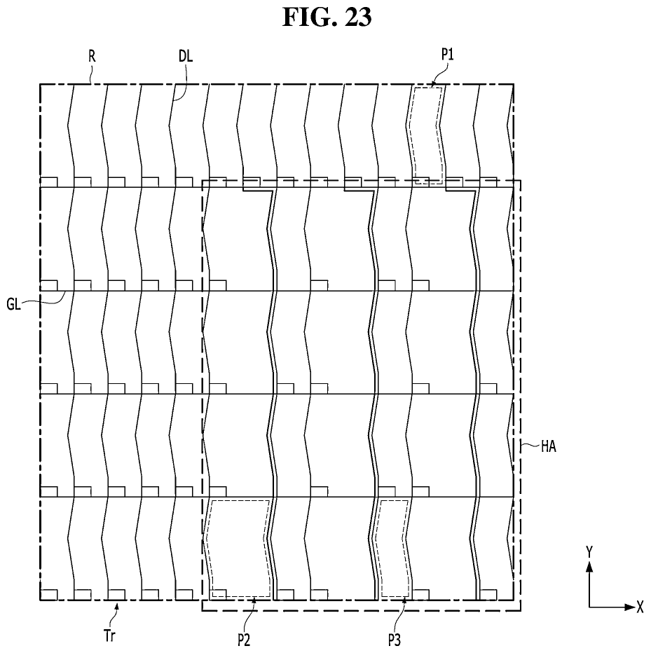

In the display apparatus according to another embodiment of the present disclosure, the second pixel areas P2 and the third pixel areas P3 having various shapes may be disposed in the sensing area HA. For example, in the display apparatus according to another embodiment of the present disclosure, each of the second pixel areas P2 in which the red color filter 151R is disposed, each of the third pixel areas P3 displaying white color, each of the second pixel areas P2 in which the blue color filter 151B is disposed, and each of the third pixel areas P3 in which the green color filter 151G is disposed may have a same length as each first pixel area P1 in the second direction Y, as shown in FIGS. 22 and 23. Thus, in the display apparatus according to another embodiment of the present disclosure, the resolution of the sensing area HA and the amount of the external light provided to the optical module through the sensing area HA may be adjusted by shapes of each second pixel area P2 and each third pixel area P3, which are disposed in the sensing area HA. Therefore, in the display apparatus according to another embodiment of the present disclosure, the degree of freedom in configuration of a shape of each second pixel area P2 and a shape of each third pixel area P3 in the sensing area HA may be improved.

As a result, the display apparatus according to the embodiments of the present disclosure may comprise the liquid crystal panel on the back-light unit and the optical module overlapping with the sensing area of the liquid crystal panel, wherein the liquid crystal panel may include the first pixel areas disposed outside the sensing area, the second pixel areas having a larger size than the first pixel areas and the third pixel areas having a smaller size than the second pixel areas, wherein the second pixel areas and the third pixel areas may be repeated in the first direction within the sensing area, wherein the length of each third pixel area in the first direction may be a same as the length of each first pixel area in the first direction, and wherein each of the third pixel areas may have a same length as each second pixel area in the second direction perpendicular to the first direction. Thus, in the display apparatus according to the embodiments of the present disclosure, the light emitted from the sensing area in which the second pixel areas and the third pixel areas are disposed may have substantially a same spatial frequency as the light emitted from the first pixel areas. That is, in the display apparatus according to the embodiments of the present disclosure, a sense of heterogeneity and incompatibility for the boundary between a first image generated by the light emitted from the sensing area and a second image generated by the light emitted from the first pixel areas may be minimized. And, in the display apparatus according to the embodiments of the present disclosure, visibility for the boundary between the first image and the second image may be reduced. Thereby, in the display apparatus according to the embodiments of the present disclosure, the quality of the image recognized to the user may be improved.

What is claimed is:

1. A display apparatus comprising:
a back-light unit including a light guide plate;
a liquid crystal panel on the back-light unit, the liquid crystal panel including first pixel areas, second pixel areas having a larger size than the first pixel areas, and third pixel areas having a smaller size than the second pixel areas; and
an optical module that is spaced apart from the light guide plate, the optical module overlapping a sensing area of the liquid crystal panel,
wherein the second pixel areas and the third pixel areas are repeated in a first direction within the sensing area,
wherein a length of each of the third pixel areas in the first direction is a same as a length of each of the first pixel areas in the first direction, and
wherein each of the third pixel areas has a same length as each of the second pixel areas in a second direction that is perpendicular to the first direction.

2. The display apparatus according to claim 1, wherein the first pixel areas are disposed outside the sensing area.

3. The display apparatus according to claim 1, wherein each of the first pixel areas displays a different color from an adjacent first pixel area from the first pixel areas in the first direction,
wherein each of the first pixel areas displays a same color as an adjacent first pixel area from the first pixel areas in the second direction, and
wherein each of the second pixel areas displays a different color from an adjacent second pixel area from the second pixel areas in the second direction.

4. The display apparatus according to claim 3, wherein each of the second pixel areas displays a first color or a second color and second pixel areas displaying the first color and second pixel areas displaying the second color are repeated in the second direction.

5. The display apparatus according to claim 3, wherein each of the third pixel areas displays a same color as an adjacent third pixel area from the third pixel areas in the first direction and the second direction.

6. The display apparatus according to claim 5, wherein each of the third pixel areas displays a green color.

7. The display apparatus according to claim 1, wherein a length of each of the second pixel areas in the first direction is an integer multiple of a length of each of the first pixel areas in the first direction.

8. The display apparatus according to claim 7, wherein a length of each of the second pixel areas in the second direction is an integer multiple of a length of each of the first pixel areas in the second direction, and
wherein the length of each of the second pixel areas in the second direction is longer than the length of each of the second pixel areas in the first direction.

9. The display apparatus according to claim 1, wherein each of the first pixel areas displays a red color, a green color, or a blue color,
wherein the liquid crystal panel includes fourth pixel areas and fifth pixel areas which are repeated with the second pixel areas and the third pixel areas in the first direction within the sensing area, and
wherein each of the fourth pixel areas and each of the fifth pixel areas has a same length as each of the third pixel areas in the first direction and the second direction.

10. The display apparatus according to claim 9, wherein each of the fourth pixel areas displays a same color as an adjacent fourth pixel area from the fourth pixel areas in the first direction and the second direction, and
wherein each of the fifth pixel areas displays a same color as an adjacent fifth pixel area from the fifth pixel areas in the first direction and the second direction.

11. The display apparatus according to claim 1, wherein the liquid crystal panel includes a plurality of first signal wirings extending in the second direction between the first pixel areas, the second pixel areas, and the third pixel areas, and
wherein a number of the plurality of first signal wirings between an adjacent second pixel area from the second pixel areas and a third pixel from the third pixel areas is larger than a number of the plurality of first signal wirings between the first pixel areas that are adjacent in the first direction.

12. The display apparatus according to claim 11, wherein the liquid crystal panel includes a plurality of second signal wirings extending in the first direction between the first pixel areas, the second pixel areas, and the third pixel areas, and
wherein a number of the plurality of second signal wirings between the second pixel areas that are adjacent in the second direction and between the third pixel areas that are adjacent in the second direction is larger than a number of the plurality of second signal wirings between the first pixel areas that are adjacent in the second direction.

13. The display apparatus according to claim 2, wherein a boundary between the second pixel areas and the third pixel areas that are adjacent in the first direction coincides with one of boundaries between the first pixel areas that are adjacent in the first direction.

14. The display apparatus according to claim 2, wherein a boundary between the second pixel areas that are adjacent in the second direction or a boundary between the third pixel areas that are adjacent in the second direction coincides with one of boundaries between the first pixel areas that are adjacent in the second direction.
